(19) United States
(12) Patent Application Publication
(10) Pub. No.: US 2002/0176419 A1
(43) Pub. Date: Nov. 28, 2002

(54) Multicast transmission method and system

(76) Inventor: Heinrich Hummel, Guending (DE)

Correspondence Address: Bell, Boyd & Lloyd LLC, P.O. Box 1135, Chicago, IL, 60690, US

(21) Appl. No.: 10/131,869

(22) Filed: Apr. 24, 2002

(30) Foreign Application Priority Data
Apr. 24, 2001 (DE) 101 20 071.4

(51) Int. Cl. H04L 12/56

(52) U.S. Cl. 370/390; 370/403

(57) ABSTRACT

A multicast transmission method and a multicast transmission system which, with nodes in a network, form one or more double-direction rings, to which a transmitter and at least some receivers are coupled.

### BACKGROUND OF THE INVENTION

The present invention relates to a transmission method and a transmission system for transmitting data from a transmitter to a group of receivers in a network (point-to-multipoint).

In network applications, data is traditionally interchanged between two subscribers. The data to be transmitted is split into individual packets or cells, provided with an address, and sent to the subscriber (receiver) in the network.

New applications such as distribution services, the transmission of video images for conferences or tele-education require simultaneous communication between groups of subscribers, or transmission of data from one subscriber (transmitter) to a group of receivers, at the same time.

Various transmission methods are used for applications such as these. If only a small group of receivers exists, the unicast method can be used. In this method, a copy of each packet is sent to each receiver in the group; that is, each receiver is addressed separately. If a large group of subscribers exists, the data is generally transmitted using the multicast method. In the multicast method, the packets are addressed to a defined group of subscribers, rather than to individual subscribers. The network itself carries out the process of passing on the multicast packets to the individual subscribers in the group. Various concepts exist for passing on these packets, which are not addressed individually.

All the concepts that exist to date for point-to-multipoint data transmission use tree-like connecting paths. This applies to all such concepts which have been standardized by the Internet Engineering Task Force (IETF) for the Internet and by the ATM Forum Technical Committee for ATM (Asynchronous Transfer Mode) networks.

A “connection tree” thus includes one, and only one, root node (transmitter node) as well as a number of transit nodes and a number of leaf nodes (receiver nodes). All the nodes are, in this case, switches or routers. The transmission terminal first sends its data to a transmitter node. The data is passed from this transmitter node via transit nodes and the individual receiver nodes to the receiver appliances on tree-like routes.

FIG. 2 shows one example of a multicast transmission method or multicast transmission system according to the prior art. The transmitter S is coupled to the network via the network node K4 (transmitter node or root node) and the receivers E1, E2 and E3 are coupled to the network via the network nodes K1, K2 and K3 (receiver nodes). The transmitter S sends data packets (which are addressed to the receiver group E1, E2, E3) to the node K4. The data packets are identified in the node K4, and are sent to the node K3. The node K3 sends a copy of each received data packet to the receiver E3 and to the nodes K1 and K2, which pass the received data packets on to the receivers E1 and E2, respectively.

This tree structure is sensitive to disturbances and defects. If, for example, the connection between the nodes K4 and K3 is subject to a disturbance or a defect or the node K3 fails, all the receivers E1, E2, E3 are disconnected from the transmitter S until a new connection has been set up between the transmitter S and the receivers E1, E2, E3. The higher the location of the disturbance or defect in the hierarchy of the tree structure, the greater the number of receivers which are generally affected by the disturbance or defect. For example, in the event of a failure of an individual transit node that is involved or of an individual feeder/output line for a transit node for Internet TV transmissions, millions of receivers may be affected in some cases.

When data is being transmitted via optical fibers, a splitter which splits the data stream into the directions of the node K1 and of the node K2 can be used in the node K3. The signal is attenuated and distorted at this splitting point. In some circumstances, a transmission system with a tree structure requires a large number of splitters, so that amplifiers or regenerators must be used in order to regenerate the signal.

An object to which the present invention is directed is to provide a multicast transmission method and multicast transmission system which are more resistant to disturbances and defects; in particular, having a tree structure in which the effects or a disturbance or defect are very largely independent of the location of the disturbance or defect in the hierarchy of the tree.

### SUMMARY OF THE INVENTION

Accordingly, pursuant to the present invention, nodes in the network form a double-direction ring, to which the transmitter and at least some of the receivers are coupled. The data packets can rotate in the opposite direction in the ring formed in this way. If the ring is interrupted at any point, for example because a node has failed or a connection between two nodes is subject to a disturbance or defect, the transmitted data packets still can be received by the receivers from one of the two directions; for example, in real-time applications. When optical fibers are used for data transmission, no splitters are required for data transmission within the ring. If the number of receivers increases, or it is necessary to form a tree structure because of the network situation, further double-direction rings are formed with nodes in the network to which some of the other receivers are coupled and which are connected to the first ring. In order to further improve the resistance of this structure to disturbances and defects, at least some of the double-direction rings have two connections for other rings. In this case, the data for data transmission in the first direction of the ring can be received via the first connection, and the data for data transmission in the second direction of the ring can be received via the second connection. The formation of a tree structure results in the production of the first and second connections of a directional ring for a hierarchically higher ring. In order to reduce the bandwidth that is used, the data is transmitted in only one direction; the data being transmitted in both directions only in the event of a disturbance or defect.

Additional features and advantages of the present invention are described in, and will be apparent from, the following Detailed Description of the Invention and the Figures.

### BRIEF DESCRIPTION OF THE FIGURES

FIG. 1 shows an example of the multicast transmission method according to the present invention.

FIG. 2 shows, schematically, the conventional procedure for multicast communication.

FIG. 3 shows a further example of the multicast transmission method according to the present invention.

FIG. 4 shows an example of the multicast transmission system according to the present invention with a tree structure.

FIG. 5 shows a further example of the multicast transmission system according to the present invention with a tree structure.

FIGS. 6a and 6b show, by way of example, the procedure for creating complex ring structures for the multicast transmission system according to the present invention.

FIGS. 7 and 8 show further examples of the multicast transmission system according to the present invention with complex ring structures.

### DETAILED DESCRIPTION OF.THE INVENTION

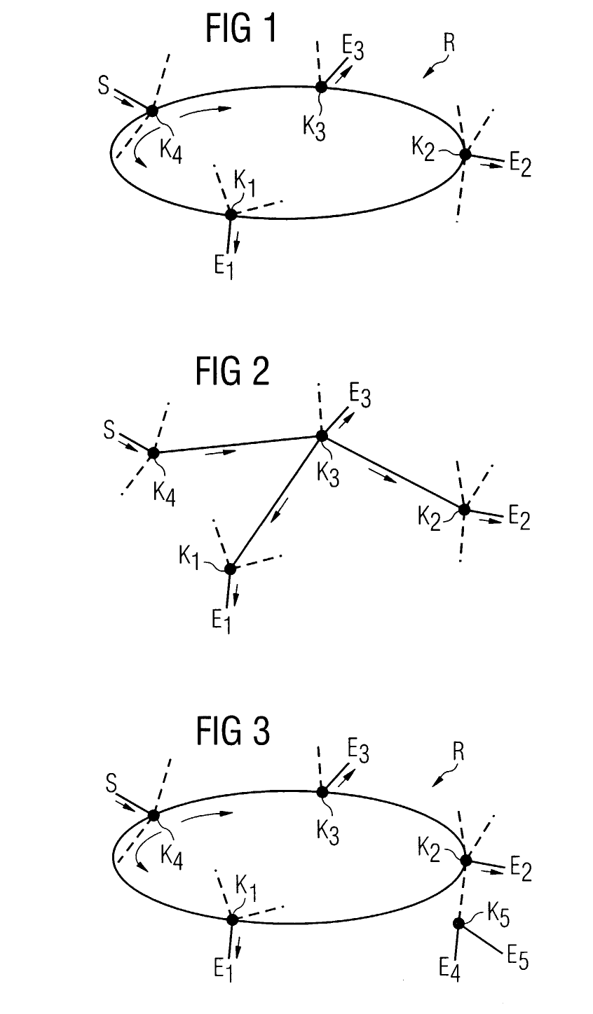

FIG. 1 shows the same network detail as FIG. 2. The transmitter S is coupled to the network via the network node K4, and the receivers E1, E2 and E3 are coupled to the network via the network nodes K1, K2 and K3. The transmitter S sends data packets (which are addressed to the receiver group E1, E2, E3) to the node K4. According to the present invention, the data packets are identified in the node K4, and a copy of each data packet is sent to the node K3 and to the node K1. From the node K1, the data packets are sent to the node K2, and from node K2 to the node K3. In the same way, the node K3 sends the data packets which it has received from the node K4 to the node K2, which sends the data packets on to the node K1, thus resulting in a double-direction ring R. The nodes K1, K2 and K3 send one of the two data packets received from the different directions to the respective receiver E1, E2 or E3. In this case, it can be agreed that each node K1, K2, K3 will send to its respective receiver E1, E2 or E3 those data packets which arrive first from one of the two directions at the node K1, K2, K3, or which the node K1, K2, K3 receives from that direction which corresponds to the shortest route to the transmitting node K1. Furthermore, for example, the transmitting node K4 monitors the data stream within the ring R, in order that each data packet passes through the ring R only once in each direction.

If the ring R is interrupted owing to a disturbance or defect between the nodes K2 and K3, the node K1 sends the data packets which it has received from the node K4 to the receiver E1, the node K2 sends the data packets transmitted via the nodes K1 and K4 to the receiver E2, and the node K3 sends the data packets received from the node K4 to the receiver E3.

If it has been agreed that a receiver node K1, K2, K3 will send the data packets from a defined first direction to its receivers E1, E2, E3, a receiver node K1, K2, K3 identifies that the data stream has stopped, for example, at the further reception of the data stream from the second direction, and passes the received data stream from the second direction on to the receiver appliances connected to it. The change to the second direction can be carried out simply after a minimum waiting time. When a change has been made to the second direction and there is still data from the first direction, there is no need to change back to the first direction.

An expansion to the ring R in the event of an increase in the number of receivers E1, E2, E3, or shrinking of the ring if the number of receivers E1, E2, E3 is reduced, can be carried out dynamically during transmission operation.

One rule for the formation of a ring R is as follows. Form a ring R which, in addition to the transmitter node K4 and any desired transit nodes K, has a set of receiver nodes K1,K2, K3 defined from the start. These receiver nodes K1, K2, K3 may, for example, be defined by representing receiver terminals E1, E2, E3 which have registered in good time for the data transmission. Later, if the ring R has to be expanded by adding a further receiver node K because there is a wish to connect a corresponding terminal E, this can be done according to the present invention in such a way that no data packets are lost and no data packet is ever transmitted twice in the same direction.

The receiver nodes K1, K2, K3 also could be “proxy” receiver nodes predetermined by administration (one such proxy receiver node for each state). For example, a multicast connection tree based on conventional technology could be connected on a state-specific basis to, in each case, one proxy receiver node.

In a simple ring R, each node K1, K2, K3, K4 receives the transmission data from both adjacent nodes and then passes this data on within the ring R in the form of a ring, except for the transmitter node K4. Furthermore, a receiver node K1, K2, K3 which is located in the ring R also passes the data on to its receiver appliances E1, E2, E3, but only once; that is to say, either that which it has received from its left-hand adjacent node in the ring, or else that which it has received from its right-hand adjacent node in the ring. The same applies to a proxy receiver node. It supplies the multicast connection tree linked to it in the conventional technology.

If it is intended to include a further receiver node K_{X} in a simple ring, or if the ring R is intended to be enlarged by such a node K_{X}, those two ring nodes K_{A} and K_{B} which are adjacent to, or close to, the node K_{X} are identified first of all. The connection route K_{A}-K_{B} must be disconnected and replaced by the connection routes K_{A}-K_{X} and K_{X}-K_{B}.

The two connection routes K_{A}-K_{X} and K_{X}-K_{B} can be set up and made ready for use, and both the node K_{A} and the node K_{B} can be informed of this, and can confirm this with one another, via signaling messages. Following the last data packet which the node K_{A} sends to the node K_{B}, the node K_{A} sends another OAM (Operation Administration Maintenance) packet after it. OAM packets are packets that are included in a connection data stream and are removed from it again; for example, for monitoring and statistics. The node K_{A} then sends the received data packets only via the node K_{X} to the node K_{B}.

The use of an OAM packet is advantageous since, in some circumstances, the circuitous route K_{A}-K_{X}-K_{B} may be the faster route, and data could arrive earlier at the node K_{B} or K_{A} via the new route than the data via the old route K_{A}-K_{B}. The node K_{B} can be instructed to place those data packets received via the new route K_{A}-K_{X}-K_{B} in a queue, until it has received the OAM packet.

The addition of the node K_{X} to the ring also can be started by breaking the connection K_{A}-K_{B}, with the data being transmitted in the same way as during a disturbance or defect while the connection route K_{A}-K_{X}-K_{B} is being set up.

Depending on the network situation, it may not be possible to couple all the receivers E1, E2, E3 to a ring R. As is shown in FIG. 3, the receivers E4 and E5 (for example, subscribers at a later stage, which are integrated in the ring R only during a “transmission pause”) are not coupled directly to the ring via the node K5. In the same way, for the purposes of the present invention, it is possible for the transmitter S to be coupled to the ring R via a secure connection or node K, which are not connected directly to the ring R.

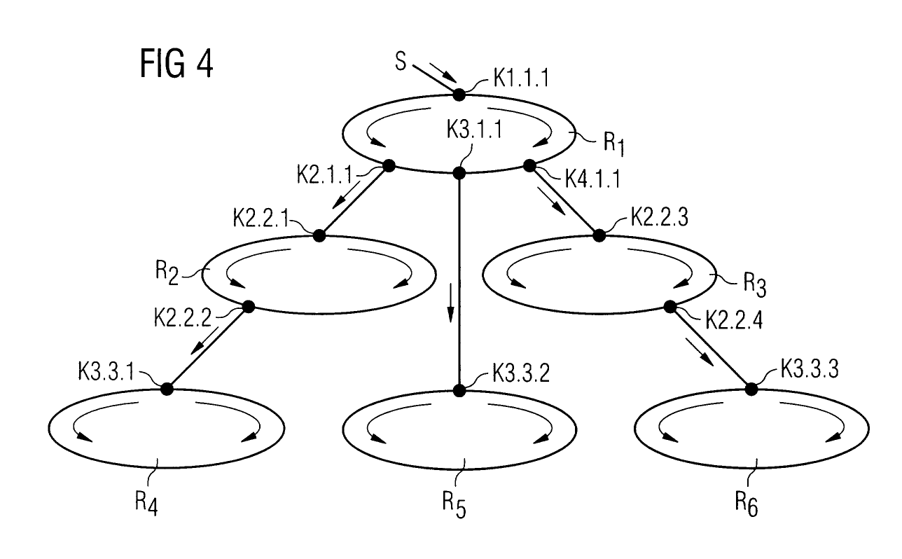

FIG. 4 shows an example of the multicast transmission system according to the present invention with a tree structure, including six rings R1 . . . R6 with three hierarchies. The receivers E1 . . . E5 together with their associated nodes K have not been shown here in the individual rings R1 . . . R6.

By way of example, the following text describes transmission of the data packets, using the system according to the present invention, on one branch of the tree structure.

The transmitter S is coupled via the node K1.1.1 to the first ring R1. The node K1.1.1 receives the data packets from the transmitter S and sends a copy in each of the two directions of the ring R1. The node K2.1.1 receives both data packets and sends one of the two to the node K2.2.1. The node K2.2.1 sends a copy of the received data packet in both of the two directions of the ring R2. In an analogous manner, the node K2.2.2 receives both data packets and sends one of them to the nodes K3.3.1. The node K3.3.1 sends a copy of the data packets in each of the two directions of the ring R4. In order to improve the resistance to disturbances and defects for the tree structure shown in FIG. 4, further connections also can be introduced between the individual rings R1 . . . R6, for example, for the respective higher hierarchy.

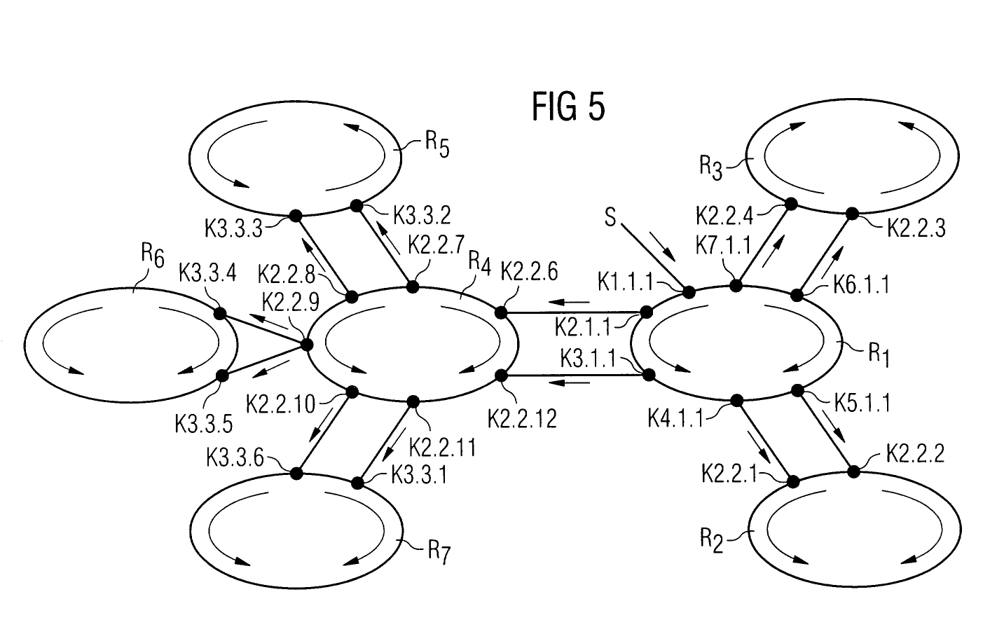

FIG. 5 shows one such advantageous tree structure including seven rings R1 . . . R7 with three hierarchies, which represents a further example according to the multicast transmission system according to the present invention. In contrast to the system in FIG. 4, each of the rings R2 . . . R7 has two connections for a hierarchically higher ring. Each node K2.1.1 . . . K3.3.6 in the overall structure thus has two (completely disjunct) connections for the transmission node K1.1.1. This has the advantage that, in the event of a disturbance to, or defect in, a connection between the rings R2 . . . R7, each ring R2 . . . R7 can receive the data packets via the second connection from the upper structure of the tree. For example, if one of the nodes K2.1.1 or K2.2.6 fails in the system shown in FIG. 5, the ring R4 in the second hierarchy receives the data packets from the transmitter S in the ring R1 of the uppermost hierarchy via the nodes K3.1.1 and K2.2.12. The system shown in FIG. 5 is formed, for example, by each of the rings R2 . . . R7 producing a connection for a hierarchically higher ring R1, R2 via one or two nodes K in the ring R2 . . . R7, and by sending the two received data packets via the node or nodes K in different directions in the ring R2 . . . R6. Particularly for data transmission via optical fibers, this has the advantage that the duplicates may be produced only once, for example by the node K1.1.1 or by the transmitter S, and are just selected and passed on by the other nodes K. This selection can be carried out via a left-hand or right-hand identification of the data packets and/or of the information, from which direction or from which node K (right-hand or left-hand adjacent node, for example known from the setting up of the connection) the data packets have been received.

In the example shown in FIG. 5, the two data packets are transmitted simultaneously via the completely disjunct connections. However, it is also possible, for example in order to save bandwidth, for only one data packet in each case to be transmitted via one path or one direction of the completely disjunct connections, and for the second path to be reserved just for transmission. In the event of a disturbance or defect in the first path, the data then can be passed via the second path, or can be diverted around the disturbance or defect point via this path. To do this, one of the nodes K which are located upstream of the disturbance or defect point and have a connection for the second path is instructed to divert the data packets to the second path. There is no need for the data packets to be returned to the first path after the disturbance or defect point. However, this may be done if sections of the second path are loaded by other subscribers in the network. It is also possible for the node K, which transmits the data packets in one direction of the ring R and is ensuring that each data packet passes through the ring R only once, to identify the absence of the transmitted data packets and to start transmission operation in both directions of the ring.

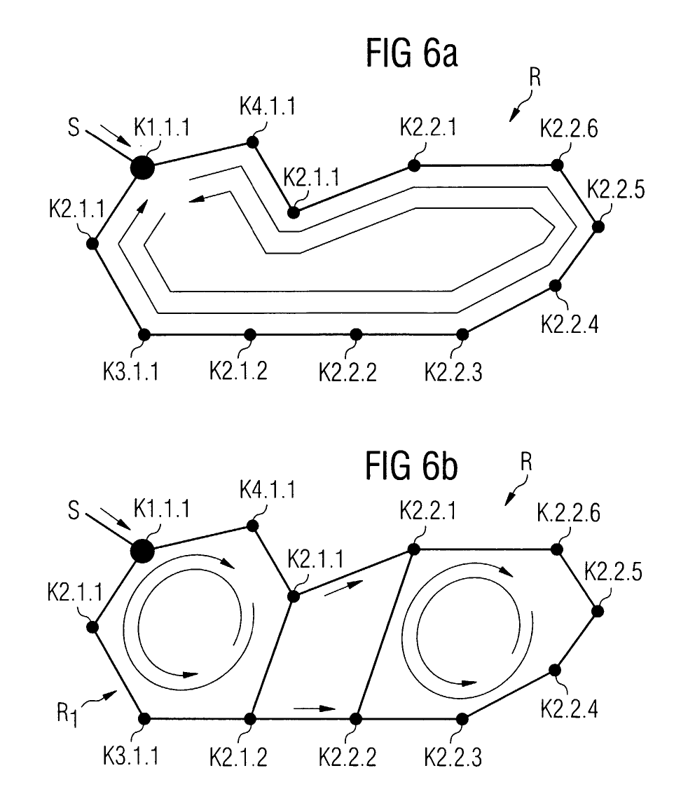

By way of example, FIGS. 6a and 6b show the procedure for creating complex ring structures for the multicast transmission system according to the present invention. In order to create the complex ring structure shown in FIG. 6a, the ring R in FIG. 6a is converted (broken up) such that two rings R1 and R2 are produced from it and connected to one another via two intermediate connections K2.1.1-K2.2.1, K2.1.2-K2.2.2. The intermediate connections K2.1.1-K2.2.1, K2.1.2-K2.2.2 may, in this case, extend over a number of transit nodes, with the two intermediate connections K2.1.1-K2.2.1 and K2.1.2-K2.2.2 not being intended to have any common nodes or physical lines in order to improve the resistance to disturbances and defects. The ring R1 is the hierarchically higher ring, and the ring R2 is the hierarchically lower ring. The data packets pass only in the direction of the hierarchically lower ring R2 via each of the two intermediate connections K2.1.1-K2.2.1, K2.1.2-K2.2.2. Before splitting up the ring R, the direction in which the data will be sent from the nodes K2.2.1 and K2.2.2 in the hierarchically lower ring R2 is defined, so that data from the nodes K2.2.1 and K2.2.2 is always passed on in the opposite direction. The nodes K2.2.1-K2.2.6 of the hierarchically lower ring R2 have, for example, addresses that are different to one another and, with regard to the leading address digits, have more commonality with the nodes K2.1.1 and K2.1.2 than with the nodes K2.1.1, K3.1.1 and K4.1.1.

Repeated splitting of rings in this way results in trees of rings, with a hierarchically higher ring being connected to a hierarchically lower ring via two intermediate connections.

In order to set up or expand a ring, it is advantageous for certain nodes in the ring to be “closely” adjacent to one another such that, when this ring is subsequently split, the configuration still ensures that they are closely adjacent, irrespective of whether this is now in the resultant hierarchically higher ring or in the hierarchically lower ring.

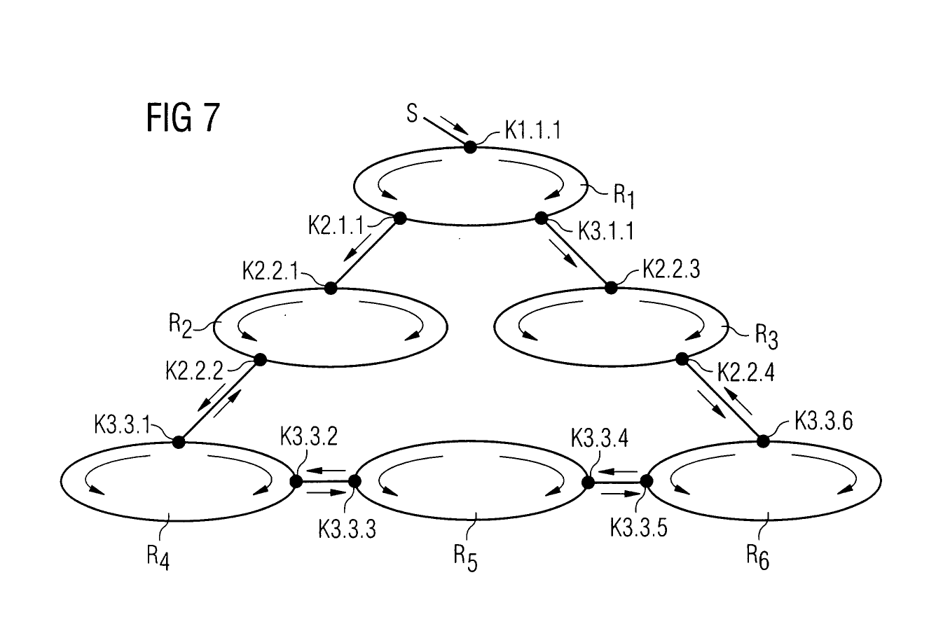

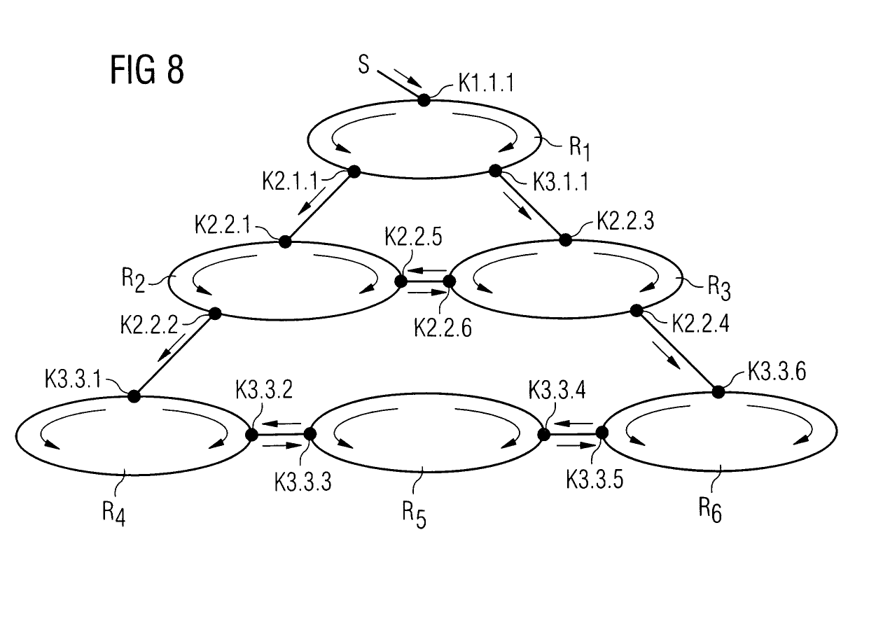

FIGS. 7 and 8 likewise show complex ring structures according to further examples of the multicast transmission system according to the present invention. Each of the rings R2 . . . R6 has a connection for a hierarchically higher ring and a connection for a ring which is not hierarchically higher, for data transmission. Thus, in the same way as the system in FIG. 5, each ring R2 . . . R6 can receive the data packets via the second connection in the event of a disturbance or defect in a connection between the rings R2 . . . R6. If, by way of example, one of the nodes K2.1.1 or K2.2.1 fails in the system shown in FIGS. 7 and 8, the ring R2 receives the data packets from the transmitter S in the system shown in FIG. 7 via the connection R1-K3.1.1-K2.2.3-R3-K2.2.4-K3.3.6-R6-K3.3.5-K3.3.4-R5-K3.3.3-K3.2.2-R4-K3.3.1-K2.2.2 and, in the system shown in FIG. 8, via the connection R1-K3.1.1-K2.2.3-R3-K2.2.6-K2.2.5.

Each device, such as a subscriber, node or router, which is connected to a network has a unique network address (IP). In the exemplary embodiments, for example, nodes K1.1.1, K2.1.1, K3.1.1 and routers are integrated in the hierarchically highest ring R1, and these nodes differ only in the uppermost address digit. A hierarchically lower ring R2 . . . R6 contains nodes K2.2.1, K2.2.2 . . . and routers whose address digits are identical in the upper digits, and differ in the lower digits.

It is, thus, possible to determine the “very close” proximity of nodes when splitting or enlarging rings via a very good match between the leading digits of the addresses of two nodes, and/or by a match between the associated Autonomous System Number (ASN), in order to ensure that different Autonomous Systems (AS) each have one or two nodes in the hierarchically higher ring as well as an AS-internal hierarchically lower ring.

In the described examples, the connection between two rings R was always produced via two nodes K. However, it is also possible for one node to connect a number of rings or for a number of rings to pass through one node.

Although the present invention has been described with reference to specific embodiments, those of skill in the art will recognize that changes may be made thereto without departing from the spirit and scope of the present invention as set forth in the hereafter appended claims.

1. A multicast transmission system in a communications network, comprising:
at least one transmitter;
a plurality of receivers; and
a plurality of nodes, wherein the plurality of nodes form a first double-direction ring to which the transmitter and at least a first portion of the plurality of receivers are coupled.

2. A multicast transmission system in a communications network as claimed in claim 1, wherein the plurality of nodes form further double-direction rings to which at least a second portion of the plurality of receivers are coupled, and to which is connected the first double-direction ring.

3. A multicast transmission system in a communications network as claimed in claim 2, wherein some of the double-direction rings have at least first and second connections for respective connection to other of the double-direction rings, with data for data transmission in a first direction of a respective ring being received via the first connection, and data for data transmission in a second direction of the respective ring being received via the second connection.

4. A multicast transmission system in a communications network as claimed in claim 3, wherein some of the double-direction rings which have first and second connections form a tree structure, with the first and second connections being formed to a hierarchically higher ring.

5. A multicast transmission system in a communications network as claimed in claim 3, wherein data is transmitted in only one direction and, upon occurrence of at least one of a disturbance and a defect, the data is transmitted in both directions, at least in some places.

6. A multicast transmission method for a communications network, the method comprising the steps of:
forming a first double-direction ring with a plurality of nodes in the network; and
coupling a transmitter in the network and at least a first portion of a plurality of receivers in the network to the first double-direction ring.

7. A multicast transmission method for a communications network as claimed in claim 6, the method further comprising the steps of:
forming further double-direction rings with the plurality of nodes in the network;
coupling at least a second portion of the plurality of receivers to the further double-direction rings; and
connecting the further double-direction rings to the first double-direction ring.

8. A multicast transmission method for a communications network as claimed in claim 7, wherein some of the double-direction rings have at least first and second connections for respective connection to other of the double-direction rings, with data for data transmission in a first direction of a respective ring being received via the first connection, and data for data transmission in a second direction of the respective ring being received via the second connection.

9. A multicast transmission method for a communications network as claimed in claim 8, further comprising the step of forming a tree structure with a plurality of the double-directional rings which have first and second connections, with the first and second connections being formed to a hierarchically higher ring.

10. A multicast transmission method for a communications network as claimed in claim 8, wherein data is transmitted in only one direction and, upon occurrence of at least one of a disturbance and a defect, the data is transmitted in both directions, at least in some places.
